(19) United States
(12) Patent Application Publication
(10) Pub. No.: US 2004/0083840 A1
(43) Pub. Date: May 6, 2004

(54) Integrated recirculation path in ball nut / ball screw

(76) Inventors: David E. King, Freeland, MI (US); Eric D. Pattok, Saginaw, MI (US); Thomas J. Bucholz, Sanford, MI (US); Raghunath P. Khetan, Troy, MI (US)

Correspondence Address: KEITH J. MURPHY, CANTOR COLBURN LLP, 55 Griffin Road South, Bloomfield, CT, 06002, US

(21) Appl. No.: 10/287,404

(22) Filed: Nov. 4, 2002

(51) Int. Cl. F16H 25/22

(52) U.S. Cl. 74/424.85; 74/424.86

(57) ABSTRACT

A ball screw assembly includes a ball nut or a ball screw having internal or external, respectively, helical curves, wherein two adjacent turns of the helical curves are joined by a crossover/crossunder path, wherein ends of the crossover/crossunder path and ends of the helical curves are integrally joined without interruption. A ball screw assembly may further include crossover/crossunder paths which are staggered about the screw or the nut.

### TECHNICAL FIELD

This invention relates to ball screw assemblies, and, more particularly, this invention relates to crossover-type ball screw assemblies which utilize continuous paths within a recirculating area for allowing balls to recirculate in their respective circuits.

### BACKGROUND OF THE INVENTION

Ball screw assemblies may be used to translate rotary motion to linear motion and linear motion to rotary motion. Most ball screw assemblies include an elongate ball screw, a number of balls, ball recirculation means, and a ball nut body. The ball nut body in cooperation with the ball screw direct a plurality of balls through an internal bearing race formed between the ball nut body and ball screw upon rotation of the ball screw. The balls translate rotary motion of the ball screw to relative linear motion of the ball nut body. Both the elongate ball screw and ball nut body commonly include a continuous helical groove which defines the internal bearing race.

In ball screw assembly applications wherein the screw proper is held in a stationary manner, or at most allowed only to translate, the associated ball nut may be designed such that the balls are recirculated in their respective circuits by way of a so-called “crossover” or “deflector” such as shown in U.S. Pat. Nos. 3,261,224, 3,667,311, 4,841,796, and 4,945,781. This is a device which allows the balls to accomplish their recirculation without need of a separate return tube. Rather, they are allowed to “skip” over the crest of the screw thread and re-enter the load zone, the aforementioned helical passage, via a path created in some additional component. Assuring that the path allows unimpeded movement of the balls has been challenging in the past.

There are challenges in designing the paths in the crossover or deflector and the corresponding ball nut. The balls must be provided a clear and continuous path via which they may be recirculated and the accurate location of an insert containing the recirculation passages is challenging.

A multi-section ball nut has been proposed wherein a curve could be ground into the nut “faces” which would compliment additional ground curvature applied to the screw as well. This multi-component stacked ball nut and ground ball screw arrangement proved prohibitively expensive to manufacture.

### SUMMARY OF THE INVENTION

The above discussed and other drawbacks and deficiencies are overcome or alleviated by a ball screw assembly including a ball nut having an internal helical curve, wherein two adjacent turns of the helical curve are joined by a crossover path, wherein ends of the crossover path and ends of the helical curve are integrally joined without interruption.

In an alternative embodiment, a ball screw assembly includes a ball screw having an external helical curve, wherein two adjacent turns of the helical curve are joined by a crossunder path, wherein ends of the crossunder path and ends of the helical curve are integrally joined without interruption.

In an alternative embodiment, a ball screw assembly includes a ball nut having a plurality of ball paths, each ball path comprising an internal helical curve and a crossover path, wherein two adjacent turns of the helical curve are joined by the crossover path to form an unending recirculation path, wherein each crossover path is staggered radially about the longitudinal axis of the ball nut from a previous crossover path.

In an alternative embodiment, a ball screw assembly includes a ball screw having a plurality of ball paths, each ball path comprising an external helical curve and a crossunder path, wherein two adjacent turns of the helical curve are joined by the crossunder path to form an unending recirculation path, wherein each crossunder path is staggered radially about the longitudinal axis of the ball screw from a previous crossunder path.

The above discussed and other features and advantages of the present invention will be appreciated and understood by those skilled in the art from the following detailed description and drawings. BRIEF DESCRIPTION OF THE DRAWINGS

The present invention will now be described, by way of example, with reference to the accompanying drawings, in which:

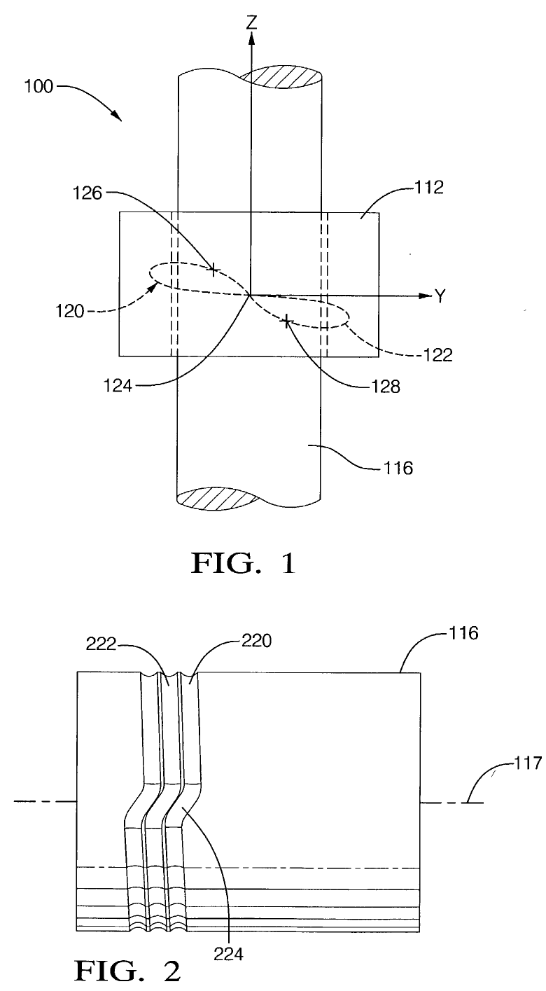

FIG. 1 is a diagrammatic view of an exemplary ball path in a ball nut;

FIG. 2 is a side plan view of a ball screw including an exemplary set of ball paths;

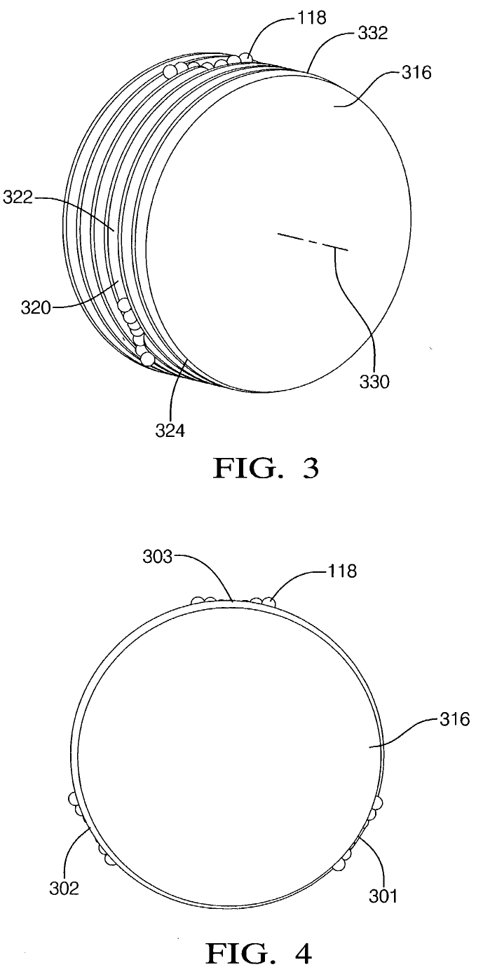

FIG. 3 is a front perspective view of a ball screw including an exemplary set of staggered ball paths;

FIG. 4 is a front plan view of the ball screw of FIG. 3;

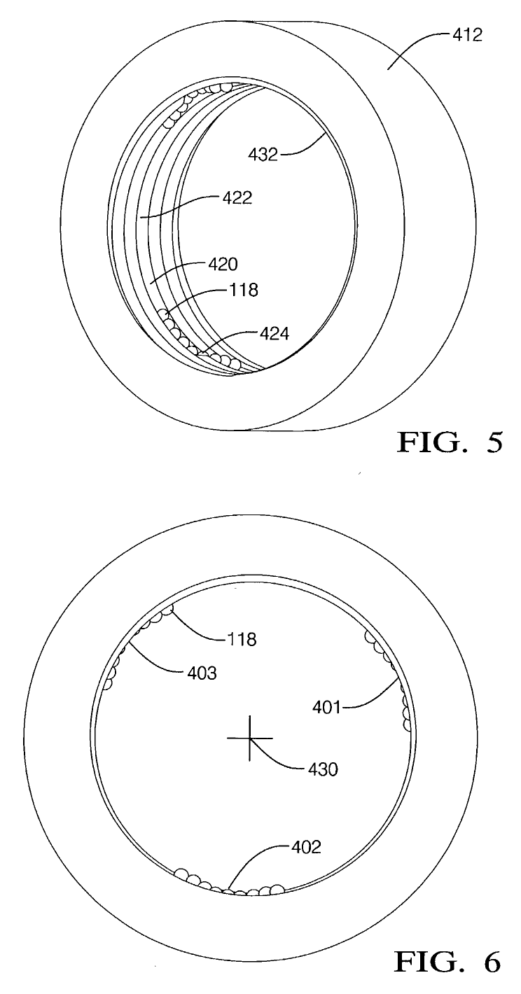

FIG. 5 is a front perspective view of a ball nut including an exemplary set of staggered ball paths; and,

FIG. 6 is a front plan view of the ball nut of FIG. 5.

### DESCRIPTION OF THE PREFERRED EMBODIMENT

As shown in FIG. 1, a ball screw assembly 100 includes a nut 112 that runs over a screw 116 wherein the screw thread 116 is cut smaller and the nut thread 112 is cut larger such that balls placed within the space between the screw 116 and the nut 112 may roll in contact with both the screw 116 and the nut 112. A crossover/crossunder path 124, also termed a ball recirculating path or ball return path, is then formed integrally with either the nut 112 or the screw 116, not requiring an additional component or means of retaining same, such that travel of the nut 112 and screw 116 with respect to each other does not result in the balls traveling outside the confines of the nut/screw interface. It should be understood that the entire crossover/crossunder path 124 is not actually visible at any one time, but is shown in its entirety in FIG. I for an understanding of its course. Also, it should be understood that if formed in a ball nut, the path would be termed a “crossover path” and if formed in a ball screw the path would be termed a “crossunder path”.

This crossover/crossunder path 124 whether placed in the nut 112 or the screw 116, should be designed such that the balls may be urged past the crest, e.g. at points 126 or 128, at the thread of the opposing element, then urged back into the helical space 122 in the previous “turn” of the nut or screw. The crossover/crossunder path 124 and the helical path 122 together combine to form a ball path 120.

Although only one ball path 120 is demonstrated in FIG. 1, it should be understood that a plurality of ball paths 120 may and probably would be employed within either the ball screw 116 and the ball nut 112, and that the other of the ball screw 116 and the ball nut 112 would contain a plurality of helical grooves. Only one exemplary ball path 120 is shown in FIG. 1 in its entirety for clarity. The ball path 120 is “unending” in the sense that a ball traveling along the ball path may be recirculated about the ball path over and over again non-stop, until the screw and nut stops. The ball path 120 is in itself unending in the sense that there is no beginning nor end to the ball path 120 as it forms an uninterrupted loop.

The crossover/crossunder path 124 further should be of such a girth and form that the balls never become pinched between the crests of corresponding nut 112 and screw 116 threads. The girth of the path 124 may not be so large as to allow the balls to deviate significantly from the desired path.

Still further, the balls preferably follow a crossover/crossunder path 124 which is continuous with the helix 122 at the thread in question, in its departure and its approach 126, 128, is tangent to the helix 122 of that same thread at these same points 126, 128, and allows the balls crossing over to be carried to a height/depth sufficient to clear the crest at the thread of the opposite element without necessarily impacting it.

When formed in the ball nut 112, the paths 120 are created internally and integrally to the ball nut 112. This may be accomplished by setting the tangency points 126, 128 of the crossover path 124 to the ball nut helix path 122 sufficiently far apart that they may be created by turning methods with, for example, the tool of a computerized milling machine holding coordinates of the ball path 120, entering the ball nut 112 from one (or either) end. Of course, other methods of creating the paths are within the scope of this invention. The intersections between the crossover path 124 and the helix path 122 are preferably smooth for improved transfer between the paths 124, 122. Also, the intersection between the crossover path 124 and the helix path is seamless, that is, there are no joints, welds, or other obstructions within the paths that may spoil the continuity of the paths. This ball nut 112 and crossover path 124 provides an advantage to the designer/manufacture of ball screw assemblies 100 by allowing for a more economical method of screw manufacture such as rolling. Similar manufacturing techniques may be modified for forming the crossunder path 124 in a ball screw.

Turning now to FIG. 2, the integrated ball path 120 may be applied to ball screws 116 (of sufficiently limited travel) as well as ball nuts 112. Crossunder paths 224, which are so named due to their location on the ball screw 116 rather than the ball nut 112, may be integrated directly into ball screws 116, thus also eliminating the need for separate crossunder inserts and their attendant alignment and retention details. Crossunder paths 224 combine with helical paths 222 to form ball paths 220 similar to ball paths 120 described above in FIG. 1. Although three ball paths 220 are shown, it is within the scope of this invention to employ more or less ball paths 220 within the ball screw 116. An advantage of this embodiment is that the external thread form existing on the exterior of the ball screw 116 is far more easily subject to many different manufacturing techniques, e.g. turning (in the soft or hardened state), milling, chasing or even rolling.

An added advantage of the crossover/crossunder paths 124 described with respect to FIG. 1 is that the crossover/crossunder paths 124 no longer must be located in the same “clock position”, as would be the case in an insert of some type, and therefore the ball nut's 112 ability to carry radial load may be greatly improved by “staggering” the crossover/crossunder paths 124, even to the point where fewer crossover/crossunder circuits are necessary to carry design loads. Turning now to FIGS. 3-4, a ball screw 316 having a center 330 through which a longitudinal axis 117, such as shown in FIG. 2, passes may include one or a plurality of ball paths 320, each having a helical path 322 and an integrally combined crossunder path 324. Also shown in FIGS. 3-4 are an exemplary set of ball bearings 118 travelling through the ball paths 320. Although only three ball paths 320 are shown, it should be understood that any number of ball paths 320 would be within the scope of this invention. Also for exemplary purposes, FIG. 4 shows that three separate ball paths 301, 302, and 303 have their crossunder paths 324 located at varying “clockwise” positions about the exterior surface 332 of the ball screw 316. That is, the substantially cylindrical and grooved outer surface 332 of the ball screw 316 may include a first ball path 301 having a crossunder path 324 located in a first position, a second ball path 302 having a crossunder path 324 located in a second position, approximately 120 degrees, measured radially from the center 330, away from the first position, and a third ball path 303 having a crossunder path 324 located in a third position, approximately 120 degrees away from the second position. Thus, in the example shown, the crossunder paths 324 from the first, second, and third ball paths 301, 302, and 303 are equally spaced about the outer surface 332 of the ball screw 316 and thus the loads carried by the ball screw assembly are efficiently balanced. While three ball paths are shown, it should be understood that a wide variety of combinations of numbers of paths and spacing between crossover paths could be employed for equally balancing the loads. For example, six paths could utilize crossunder paths which are spaced apart 60 degrees from each adjacent path, or alternatively spaced apart 120 degrees from each adjacent path such that the first set of three paths and the second set of three paths are identical. Alternatively, it is also within the scope of this invention to provide for uneven spacing of the crossunder paths 324 from each other. For example, a second crossunder path may be spaced 60 degrees from a first crossunder path, and a third crossunder path may be spaced 50 degrees from the second crossunder path. Of course, the examples given are only a sampling of the possibilities for arranging the crossunder paths in a staggered fashion about the ball nut or ball screw, and any pattern of arrangement, including even and uneven spacing, is within the scope of this invention. It should be further noted in FIGS. 3 and 4 that the crossunder paths 324 employ more deeply cut grooves into the outer surface 332 of the ball screw than the helical paths 322. This allows the balls 118 to skip over the threads of the outwardly surrounding ball nut 112 so that the balls 118 can continue along with the helical paths 322.

Turning now to FIGS. 5-6, the same concept discussed above with respect to FIGS. 3-4 is employed within a ball nut 412 instead of the ball screw 316. A ball nut 412 having a center 430 through which a longitudinal axis passes may include one or a plurality of ball paths 420, each having a helical path 422 and an integrally combined crossover path 424. Also shown in FIGS. 5-6 are an exemplary set of ball bearings 118 travelling through the ball paths 420. Although only three ball paths 420 are shown, it should be understood that any number of ball paths 420 would be within the scope of this invention. Also for exemplary purposes, FIG. 6 shows that three separate ball paths 401, 402, and 403 have their crossover paths 424 located at varying “clockwise” positions about the interior surface 432 of the ball nut 412. That is, the substantially cylindrical and grooved inner surface 432 of the ball nut 412 may include a first ball path 401 having a crossover path 424 located in a first position, a second ball path 402 having a crossover path 424 located in a second position, approximately 120 degrees, measured radially from the center 430, away from the first position, and a third ball path 403 having a crossover path 424 located in a third position, approximately 120 degrees away from the second position. Thus, in the example shown, the crossover paths 424 from the first, second, and third ball paths 401, 402, and 403 are equally spaced about the inner surface 432 of the ball nut 412 and thus the loads carried by the ball screw assembly are efficiently balanced. Again, while three ball paths are shown, it should be understood that a wide variety of combinations of numbers of paths and spacing between crossover paths could be employed for equally balancing the loads. For example, six paths could utilize crossover paths which are spaced apart 60 degrees from each adjacent path, or alternatively spaced apart 120 degrees from each adjacent path such that the first set of three paths and the second set of three paths have are identical. It should be further noted in FIGS. 5 and 6 that the crossover paths 424 employ more deeply cut grooves into the interior surface 432 of the ball nut 412 than the helical paths 422. This allows the balls 118 to skip over the threads of the inwardly placed ball screw 116 so that the balls 118 can continue along with the helical paths 422.

While the ability to stagger the crossover/crossunder paths is simplified by the integral construction of the screws and nuts as described above, it is also within the scope of this invention to provide the staggered crossover or crossunder paths within separate inserts, although the manufacture of such an embodiment may be prohibitively expensive.

Using the integrated ball nut/ball screw and crossover/crossunder as described above, separate components employed to contain the ball crossover/crossunder paths 124, 224, 324, 424 are unnecessary, thus reducing the total parts count and assembly complexity. Solitary integral screws and nuts assure smooth progress of balls within the ball paths. Another advantage is that the ball paths 120, 220, 320, 420 may now be made continuous, with no interruptions at all between the helical path 122, 222, 322, 422 and the crossover/crossunder path 124, 224, 324, 424.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A ball screw assembly comprising:
a ball nut having an internal helical curve, wherein two adjacent turns of the helical curve are joined by a crossover path, wherein ends of the crossover path and ends of the helical curve are integrally formed without interruption.

2. The ball screw assembly of claim 1 further comprising a plurality of helical curves and a plurality of crossover paths, each crossover path connected to ends of a helical curve to form an uninterrupted loop.

3. The ball screw assembly of claim 2 wherein the crossover paths are staggered radially about a longitudinal axis of the ball nut.

4. The ball screw assembly of claim 3 wherein the crossover paths are spaced unevenly apart about the longitudinal axis of the ball nut.

5. The ball screw assembly of claim 3 wherein a first crossover path is spaced n degrees from a second crossover path, and a second crossover path is spaced n degrees from a third crossover path.

6. The ball screw assembly of claim 1 wherein the helical curves and the crossover path combine to form a ball path for recirculation, wherein the ball path is smooth and continuous at intersections between the crossover path and the helical curves.

7. The ball screw assembly of claim 6 further comprising a screw having external helical threads and further comprising a plurality of balls placed within the ball path wherein the balls are contained between the ball nut and the ball screw within the ball path, and further wherein the balls are recirculated through the ball path.

8. The ball screw assembly of claim 1 wherein the ball nut, including a portion containing the crossover path, is a solitary unit.

9. A ball screw assembly comprising:
a ball screw having an external helical curve, wherein two adjacent turns of the helical curve are joined by a crossunder path, wherein ends of the crossunder path and ends of the helical curve are integrally formed without interruption.

10. The ball screw assembly of claim 9 further comprising a plurality of helical curves and a plurality of crossunder paths, each crossunder path connected to ends of a helical curve to form an uninterrupted loop.

11. The ball screw assembly of claim 10 wherein the crossunder paths are staggered radially about a longitudinal axis of the ball screw.

12. The ball screw assembly of claim 11 wherein the crossunder paths are spaced unevenly apart about the longitudinal axis of the ball screw.

13. The ball screw assembly of claim 11 wherein a first crossunder path is spaced n degrees from a second crossunder path, and a second crossunder path is spaced n degrees from a third crossunder path.

14. The ball screw assembly of claim 9 wherein the helical curves and the crossunder path combine to form a ball path for recirculation, wherein the ball path is smooth and continuous at intersections between the crossunder path and the helical curves.

15. The ball screw assembly of claim 14 further comprising a ball nut having internal helical threads and further comprising a plurality of balls placed within the ball path wherein the balls are contained between the ball nut and the ball screw within the ball path, and further wherein the balls are recirculated through the ball path.

16. The ball screw assembly of claim 9 wherein the ball screw, including a portion containing the crossunder path, is a solitary unit.

17. A ball screw assembly comprising:
a ball nut having a plurality of ball paths, each ball path comprising an internal helical curve and a crossover path, wherein two adjacent turns of the helical curve are joined by the crossover path to form an unending recirculation path;
wherein each crossover path is staggered radially about the longitudinal axis of the ball nut from a previous crossover path.

18. The ball screw assembly of claim 17 wherein a first crossover path is spaced n degrees from a second crossover path, and a second crossover path is spaced n degrees from a third crossover path.

19. The ball screw assembly of claim 17 wherein the crossover paths are spaced unevenly apart about the longitudinal axis of the ball nut.

20. A ball screw assembly comprising:
a ball screw having a plurality of ball paths, each ball path comprising an external helical curve and a crossunder path, wherein two adjacent turns of the helical curve are joined by the crossunder path to form an unending recirculation path;
wherein each crossunder path is staggered radially about the longitudinal axis of the ball screw from a previous crossunder path.

21. The ball screw assembly of claim 19 wherein a first crossunder path is spaced n degrees from a second crossunder path, and a second crossunder path is spaced n degrees from a third crossunder path.

22. The ball screw assembly of claim 19 wherein the crossunder paths are spaced unevenly apart about the longitudinal axis of the ball screw.

23. A ball screw assembly comprising:
a ball nut;
a ball screw;
a ball path formed within one of the ball nut and ball screw, wherein the ball path includes a helical curve and a recirculating path, wherein two ends of the helical curve and ends of the recirculating path are integrally formed without interruption, wherein the ball path is seamless and unending.
